(19) United States
(12) Patent Application Publication
(10) Pub. No.: US 2014/0077100 A1
(43) Pub. Date: Mar. 20, 2014

(54) MICROORGANISM DETECTING APPARATUS CALIBRATION METHOD AND MICROORGANISM DETECTING APPARATUS CALIBRATION KIT

(71) Applicant: Azbil Corporation, Tokyo (JP)

(72) Inventor: Norio HASEGAWA, Tokyo (JP)

(73) Assignee: AZBIL CORPORATION, Tokyo (JP)

(21) Appl. No.: 14/026,272

(22) Filed: Sep. 13, 2013

(30) Foreign Application Priority Data
Sep. 14, 2012 (JP) 2012-202285

(51) Int. Cl. G01N 21/64

(52) U.S. Cl. CPC G01N 21/64
USPC 250/459.1; 526/346; 428/402

(57) ABSTRACT

A method for calibrating a microorganism detecting apparatus includes drawing into the microorganism detecting apparatus polystyrene particles with a weight-average molecular weight of no less than 250,000 and no more than 850,000 that, when exposed to light, produce a fluorescence of an intensity that is substantially identical to an intensity of fluorescence produced by a microorganism. The polystyrene particles are exposed to light from a light source of the microorganism detecting apparatus. A fluorescence detector of the microorganism detecting apparatus detects the fluorescence produced by a polystyrene particle. The microorganism detecting apparatus is calibrated based on a detected intensity of the fluorescence.

### CROSS REFERENCE TO RELATED APPLICATION

This application claims priority under 35 U.S.C. § 119 to Japanese Patent Application No. 2012-202285, filed on Sep. 14, 2012, the entire content of which being hereby incorporated herein by reference.

### FIELD OF TECHNOLOGY

The present invention relates to an environment evaluating technology, and, in particular, relates to a microorganism detecting apparatus calibration method and microorganism detecting apparatus calibration kit.

### BACKGROUND

In clean rooms in, for example, pharmaceutical product manufacturing factories, the quantity of microorganisms suspended within the air in the room is monitored using a microorganism detecting apparatus. When evaluating the performance of the microorganism detecting apparatus, or calibrating the accuracy thereof, known microorganisms are drawn into the microorganism detecting apparatus to evaluate the output of the microorganism detecting apparatus. See, for example, Japanese Unexamined Patent Application Publications 2004-159508, 2008-22764 and 2008-22765.

However, microorganisms that are used when evaluating the microorganism detecting apparatus have the potential to contaminate the environment such as the clean room, the chamber, or the like. Given this, one of aspects of the present invention is to provide a calibration method for a microorganism detecting apparatus, and a calibration kit for the microorganism detecting apparatus, that do not use microorganisms.

### SUMMARY

An example of the present invention provides a microorganism detecting apparatus calibration method including drawing into the microorganism detecting apparatus polystyrene particles with a weight-average molecular weight of no less than 250,000 and no more than 850,000 that, when exposed to light, produce fluorescence of substantially identical intensity to the intensity of fluorescence produced by microorganisms, exposing the polystyrene particles with light to a light source of the microorganism detecting apparatus and detecting, using a fluorescence detector of the microorganism detecting apparatus, the fluorescence produced from the polystyrene particles, and calibrating the microorganism detecting apparatus based on the intensity of the detected fluorescence.

Moreover, another example according to the present invention provides a microorganism detecting apparatus calibration kit including polystyrene particles with a weight-average molecular weight of no less than 250,000 and no more than 850,000 that, when exposed to light, produce fluorescence of substantially the identical intensity to the intensity of the fluorescence that is produced by microparticles.

The present invention enables the utilization of a microorganism detecting apparatus calibration method and a microorganism detecting apparatus calibration kit that does not use microorganisms.

### BRIEF DESCRIPTIONS OF THE DRAWINGS

FIG. 1 is a schematic diagram of a test chamber in an example according to the present invention.

FIG. 2 is a schematic cross-sectional diagram of a microorganism detecting apparatus in an example according to the present invention.

FIG. 3 is a graph showing the distributions of fluorescence intensities for polystyrene particles and microorganisms observed under a fluorescent microscope under dry conditions in an example according to the present invention.

FIG. 4 is a graph showing the 95% confidence intervals for fluorescence intensities for polystyrene particles observed under a fluorescent microscope under dry conditions in an example according to the present invention.

FIG. 5 is a graph showing the fluorescence intensities for polystyrene particles and microorganisms observed under a fluorescent microscope in an example according to the present invention.

FIG. 6 is a graph showing the relationship between the weight-average molecular weights of the material for the polystyrene particles and the strength of the fluorescent light in an example according to the present invention.

FIG. 7 is a graph showing the distributions for fluorescence intensities for polystyrene particles observed under a fluorescent microscope under in-fluid conditions in an example according to the present invention.

FIG. 8 is a graph showing the 95% confidence intervals for fluorescence intensities for polystyrene particles observed under a fluorescent microscope under in-fluid conditions in an example according to the present invention.

FIG. 9 is a graph showing the fluorescence intensities for polystyrene particles and microorganisms detected by an airborne microbe detector in an example according to the present invention.

### DETAILED DESCRIPTION

An example of the present invention will be described below. In the descriptions of the drawings below identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

The method for calibrating a microorganism detecting apparatus according to an example includes drawing into the microorganism detecting apparatus polystyrene particles with a weight-average molecular weight of no less than 250,000 and no more than 850,000 that, when exposed to light, produce fluorescence of substantially the same intensity as the intensity of fluorescence produced by microorganisms. In one example, the method includes exposing the polystyrene particles to light from a light source of the microorganism detecting apparatus and detecting, using a fluorescence detector of the microorganism detecting apparatus, the fluorescence produced from the polystyrene particles, and calibrating the microorganism detecting apparatus based on the intensity of the detected fluorescence.

The weight-average molecular weight MW was defined by the following expression. In the expression below, N is the number of polymer molecules, M is the molecular weight, and C is the sample concentration. The sample concentration C (wt./vol.) is proportional to the number of monomer units, and thus C=M·N.

$$Mw = \frac{\sum ( {M}_{i}^{2} \cdot {N}_{i} )}{\sum ( {M}_{i} \cdot {N}_{i} )} = \frac{\sum ( {C}_{i} \cdot {M}_{i} )}{\sum {C}_{i}} \qquad Expression 1$$

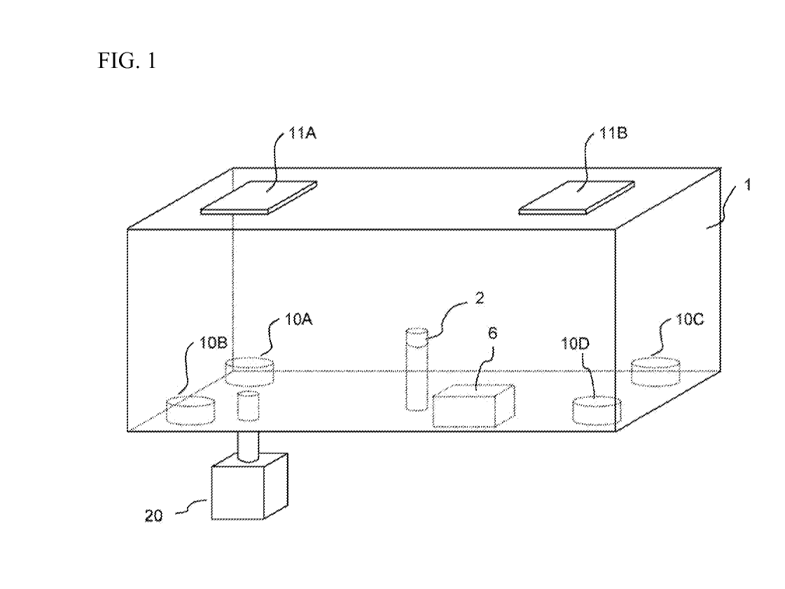

As illustrated in FIG. 1, a microorganism detecting apparatus 20 that is the subject of the calibration method is disposed in, for example, a test chamber 1. The test chamber 1 is a chamber that is provided with, for example, an aluminum frame and transparent panels, made from polycarbonate, fitted into the frame to serve as side walls. Air supplying devices 11A and 11B, for example, are provided in the test chamber 1. The air supplying devices 11A and 11B supply, into the test chamber 1, clean air through ultrahigh performance air filters such as HEPA filters (High Efficiency Particulate Filters) or ULPA filters (Ultra Low Penetration Air Filters), or the like. A door may be provided in a side wall of the test chamber 1.

The polystyrene particles according to the example are discharged into the interior of the test chamber 1 from a spraying device 2 that is equipped in the test chamber 1. The spraying device 2 is, for example, a jet-type nebulizer, and holds a fluid that includes polystyrene particles at a prescribed concentration. In the spraying device 2, a gas flow, such as of a compressed gas, is provided with a prescribed flow rate, where the gas flow blows into the fluid that includes the polystyrene particles to produce an aerosol, to spray in the form of a mist, into the interior of the test chamber, the fluid that includes the polystyrene particles. Note that while in the FIG. 1 the spraying device 2 is disposed within the test chamber 1, the spraying device 2 may instead be disposed on the outside of the test chamber 1, with the aerosol that is sprayed by the spraying device 2 directed into the test chamber 1 through ducting, or the like.

Agitating fans 10A, 10B, 10C, and 10D are disposed as agitating devices within the test chamber 1. The agitating fans 10A through 10D agitate the air within the test chamber 1, to prevent natural settling, by their own weight, of the polystyrene particles that are dispersed into the air within the test chamber 1.

Moreover, an air cleaner 6, as a cleaning device, is disposed within the test chamber 1. The air cleaner 6 removes particles that are included in the gas, such as air, or the like, within the test chamber 1, to clean the gas. For example, prior to spraying the fluid that contains the polystyrene particles into the test chamber 1 from the spraying device 2, the air cleaner 6 can be run to remove in advance, from within the test chamber 1, any microparticles or microorganisms other than the polystyrene particles that are to be sprayed from the spraying device 2. Note that while in FIG. 1 the air cleaner 6 is disposed on the bottom surface within the test chamber 1, the air cleaner 6 may instead be disposed on a wall or the ceiling of the test chamber 1.

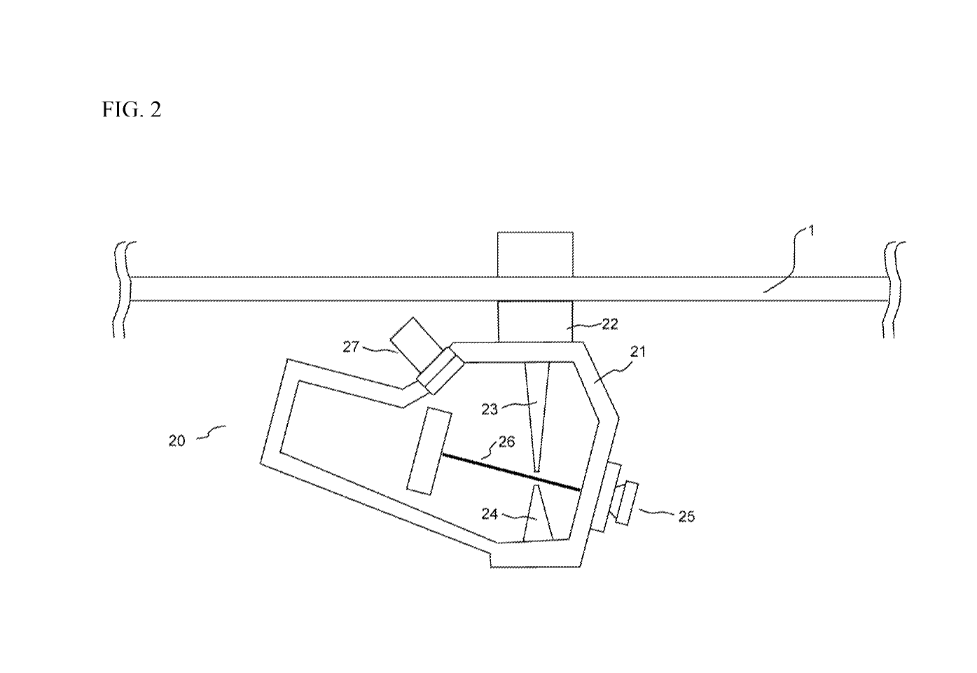

As illustrated in the schematic cross-sectional diagram in FIG. 2, for example, the microorganism detecting apparatus 20 is provided with a frame 21 and a first vacuum device 22 for dry air from within the test chamber 1 into the interior of the frame 21. The air drawn in by the first vacuum device 22 is expelled from the tip of a nozzle 23 within the frame 21. The air that is expelled from the tip of the nozzle 23 is drawn in by a second vacuum 24, disposed within the frame 21, facing the tip of the nozzle 23. The microorganism detecting apparatus 20 is provided further with a light source 25, such as a laser. The light source 25 directs a laser beam 26 toward the air that is drawn by the second vacuum device 24. The laser beam 26 may be of visible light, or may be of ultraviolet radiation. If the laser beam 26 is of visible light, then the wavelength of the laser beam 26 is within a range of, for example, between 400 and 410 nm, for example, 405 nm. If the laser beam 26 is of ultraviolet radiation, then the wavelength of the laser beam 26 is in a range of, for example, between 310 and 380 nm, for example, 340 nm.

When microorganisms, such as microbes, or the like, exist within the air, the microbes that are exposed to the laser beam 26 produce fluorescence. Examples of such microbes include Gram-negative bacteria, Gram-positive bacteria, and fungi such as mold spores. Escherichia coli, for example, can be listed as an example of a Gram-negative bacterium. Staphylococcus epidermidis, Bacillus atrophaeus, Micrococcus lylae, and Corynebacterium afermentans can be listed as examples of Gram-positive bacteria. Aspergillus niger can be listed as an example of a fungus such as a mold spore. The microorganism detecting apparatus 20 is further equipped with a fluorescence detector 27. The fluorescence detector 27 detects the fluorescence produced by the microorganisms and measures the intensity of the fluorescence. The microorganism detecting apparatus 20, based on the magnitude of the fluorescence intensity, is able to measure the concentration of the microorganisms that exist in the air.

When calibrating the microorganism detecting apparatus 20, preferably all dust, dirt, microparticles, microorganisms, and the like are completely removed from within the test chamber 1, illustrated in FIG. 1, by the air cleaner 6, and polystyrene particles are discharged from the spraying device 2. The air containing the polystyrene particles that have been discharged is drawn into the microorganism detecting apparatus 20, to be illuminated by the laser beam 26 shown in FIG. 2. While typically polystyrene particles are not categorized as fluorescent materials, the polystyrene particles that have been exposed to the laser beam 26 produce intrinsic fluorescence. Here what the inventors discovered for the first time was that the intensity of the autofluorescence emitted from one polystyrene particle with a weight-average molecular weight of no less than 250,000 and no more than 850,000 is substantially equivalent to the intensity of the fluorescence emitted by one microbe. Because of this, it is possible to calibrate the sensitivity, and the like, of the fluorescence detector 27 of the microorganism detecting apparatus 20 using polystyrene particles with a weight-average molecular weight of no less than 250,000 and no more than 850,000 instead of using microorganisms.

The intensity of the fluorescence produced by the polystyrene particles will vary depending on the weight-average molecular weight of the material of the polystyrene particle and on the particle size. Consequently, polystyrene particles each of multiple different materials with different weight-average molecular weights and different sizes may each be drawn into the microorganism detecting apparatus 20, to evaluate whether or not the fluorescence detector 27 of the microorganism detecting apparatus 20 has the sensitivity enough to be able to discern the differences in the respective fluorescence intensities of the polystyrene particles with the respectively different weight-average molecular weight materials and sizes.

Polystyrene particles are made from, for example, polystyrene.

The weight-average molecular weights of the polystyrene particles made essentially from polystyrene are preferably are no less than 250,000 and up to 850,000, and more preferably, no less than 300,000 and up to 750,000. If the weight-average molecular weight of the material of the polystyrene particle made essentially from polystyrene were to be less than 250,000, then the intensity of fluorescence produced by a single polystyrene particle would tend to be weaker than the intensity of the fluorescence produced by a single microorganism. Moreover if the weight-average molecular weight of the material of the polystyrene particle made essentially from polystyrene were to be greater than 850,000, then the intensity of fluorescence produced by a single polystyrene particle would tend to be stronger than the intensity of the fluorescence produced by a single microorganism.

Moreover, the diameters of the polystyrene particles that are made essentially from polystyrene are preferably are no less than 0.75 μm and up to 10 μm, and more preferably, no less than 0.75 μm and up to 5 μm. If the particle size of the polystyrene particle made essentially from polystyrene were to be less than 0.75 μm, then the intensity of fluorescence produced by a single polystyrene particle would tend to be weaker than the intensity of the fluorescence produced by a single microorganism. Moreover, if the particle size of the polystyrene particle made essentially from polystyrene were to be 10 μm or more, then the intensity of the fluorescence produced by a single polystyrene particle would tend to be greater than the intensity of fluorescence produced by a single microorganism. There is practically no limitation to the range set forth above insofar as the size of the polystyrene particles made from polystyrene is selected so that, substantially, the intensity of the fluorescence produced when a polystyrene particle is exposed to light is nearly identical to the intensity of the fluorescence produced by a microorganism.

Conventionally, when calibrating a microorganism detecting apparatus, microorganisms of a known concentration are drawn into the microorganism detecting apparatus and calibration is performed so that the microorganism concentration calculated by the microorganism detecting apparatus, compared to the actual microorganism concentration, will be equal. However, because microorganisms require culturing facilities and safety equipment for preventing leakage, there is a problem in that the calibration of the microorganism detecting apparatus is quite costly. In contrast, the use of polystyrene particles in calibrating the microorganism detecting apparatus eliminates the need for culturing facilities and for safety equipment, thus making it possible to substantially reduce the cost involved in the calibration of the microorganism detecting apparatus.

Furthermore, the fluorescence produced by the microorganism will vary depending on the conditions of growth for the microorganisms, as described in Applied Microbiology and Biotechnology, Vol. 30, 59-66 and the Chemical Engineering Journal, Vol. 34, B7-B12. Because of this, even when performing the calibration of a microorganism detecting apparatus using microorganisms, it still may not be possible to obtain indicators for setting the target value (threshold value) for the sensitivity of the fluorescence detector of the microorganism detecting apparatus. In contrast, because the intensities of the fluorescence produced by the polystyrene particles is stable, use of polystyrene particles in calibrating microorganism detecting apparatuses makes it possible to perform the calibration of the microorganism detecting apparatuses reliably.

### EXAMPLES

While a more specific description will be provided below with examples, the present invention is in no ways limited by the examples set forth below.

### Obtaining the Polystyrene Particles

For the polystyrene particles, Thermal Scientific Nanosphere 3000-series size-standard product no. 3500A, Latex Microsphere Suspensions 5000-series product no. 5100A, and Duke Standards 4000-series Monosized Particles product nos. 4203A and 4205A were obtained from Fisher Scientific.

The particles of product no. 3500A were supplied as a suspension, with a particle size of 498 nm±9 nm (coefficient of variance: no more than 1.6%), where the material was polystyrene with a density of 1.05 g/cm³, and an index of refraction of 1.59. The product no. 3,500A particles had particle size uniformity adequate to enable their use as a reference sample for a 0.5 μm particle size.

The particles of product no. 5100A were supplied as a suspension, with a particle size of 1.0 μm (coefficient of variance: no more than 3%), where the material was polystyrene with a density of 1.05 g/cm³, and an index of refraction of 1.59.

The particles of product no. 4203A were supplied as a suspension, with a particle size of 3.002 μm±0019 (coefficient of variance: 1.1%), where the material was polystyrene. The product no. 4,203A particles had particle size uniformity adequate to enable their use as a reference sample for a 3 μm particle size.

The particles of product no. 4205A were supplied as a suspension, with a particle size of 4.993 μm±0040 (coefficient of variance: 1.0%), where the material was polystyrene. The product no. 4205A particles had particle size uniformity adequate to enable their use as a reference sample for a 5 μm particle size.

### Rinsing the Polystyrene Particles

1 mL of a suspension of a polystyrene particle that was obtained was transferred to a microcentrifuge tube, and a centrifuge (Hitachi Koki, model CT13R) was used to perform centrifugation for five minutes at 13,000 g. The supernatant was removed and discarded. Following this, the polystyrene particles were resuspended in sterile distilled water. Thereafter, the centrifugation and resuspension of the polystyrene particles was repeated twice more to rinse the polystyrene particles. The volume of the sterile distilled water that was the medium for the suspension of polystyrene particles ultimately obtained was 0.5 mL.

### Measuring the Weight-Average Molecular Weight of the Polystyrene Particle Material

The respective polystyrene particles that were prepared were dissolved in tetrahydrofuran (THF). Following this, the dissolved solution of polystyrene particles was filtered through a 0.45 μm membrane filter. Thereafter, a gel permeation chromatography method was used to measure the weight-average molecular weight of the material of the polystyrene particles. Specifically, two TSKgel SuperHM-H (Tosoh Corp.) and one SuperH2500 (Tosoh Corp.) were used in the column. The column temperature was maintained at 40° C. Following this, 40 μL of the dissolved solution of the polystyrene particles was delivered into the column at a flow rate of 0.6 mL per minute. Standard polystyrene was used for the molecular weight reference. A refractive index detector was used to detect the polymers included in the eluent from the column.

The result was that the weight-average molecular weight of the product no. 3500A particles was 230,000. The weight-average molecular weight of the product no. 5100A particles was 340,000. The weight-average molecular weight of the product no. 4,203A particles was 650,000. The weight-average molecular weight of the product no. 4,205A particles was 820,000.

### Obtaining the Microorganisms

The microorganisms obtained were Escherichia coli (abbreviated “E. coli,” ATCC 13706), Staphylococcus epidermidis (abbreviated “S. epidermidis,” ATCC 12228), Bacillus atrophaeus (abbreviated “B. atrophaeus,” ATCC 9372), Micrococcus lylae (abbreviated “M. lylae,” ATCC 27566), Corynebacterium afermentans (abbreviated “C. afermentans,” ATCC 51403), and Aspergillus niger (abbreviated “A. niger,” ATCC 9142). Note that ATCC is an abbreviation for the “American Type Culture Collection.”

The E. coli is a Gram-negative bacterium. Staphylococcus epidermidis, Bacillus atrophaeus, Micrococcus lylae, and Corynebacterium afermentans are Gram-positive bacteria. The A. niger is also known as black aspergillus, and is a type of mold spore.

### Method for Preparing the Microorganisms

The E. coli, S. epidermidis, and M. lylae were inoculated into 3 mL each of a tryptic soy broth (Becton, Dickinson and Company, Ref: 211825), and left overnight at 32° C., to be cultured aerobically. When further culturing the E. coli, S. epidermidis, and M. lylae on an agar medium, emulsions of the bacteria were streaked onto a tryptic soy agar medium (Eiken Chemical Company, Ltd.: E-MP25), and left overnight at 32° C. to be cultured aerobically.

When culturing the C. afermentans, an R medium (10 g peptone, 5 g yeast extract, 5 g malt extract, 5 g casamino acid, 2 g beef extract, 2 g glycerin, 50 mg Tween 80,1 g MgSO₄.7H₂O, and 1 L distilled water, pH7.2) was used as the liquid culture medium, and a sheep blood agar was used as the agar.

When preparing the microorganisms from the liquid culture medium, a centrifuge (Kubota Trading Company: 2410 or Hitachi Koki: CT13R) was used to centrifuge the culture solution for three minutes at 2100 g to collect the bacteria from the culture solution, and then, after removing and discarding the supernatant medium, the microorganisms were resuspended in sterile distilled water. Thereafter, the centrifugation and resuspension of the microorganisms was repeated twice more to rinse the microorganisms. The volume of the sterile distilled water that was the medium for the suspension of microorganisms ultimately obtained was 3 mL.

When preparing the microorganisms from the agar, colonies were scraped off of the agar and suspended in 5 mL of sterile distilled water. Following this, after lightly vortexing the suspension to disperse the microorganisms, the microorganisms were collected through centrifuging the suspension for three minutes at 2100 g and removing and discarding the supernatant, to produce the clean microorganisms. Thereafter, the microorganisms were resuspended in 5 mL of sterile distilled water.

For the B. atrophaeus, a commercially available spore solution (North American Science Associates, Inc.: SUN-07) was used.

For the A. niger, culturing was performed on a potato dextrose agar (Ai Science Laboratory: PM0002-1), and A. niger that had been stored at 4° C. was injected, using a needle, into the medium and cultured for one week at 25° C. to produce spores. Following this, approximately 10 mL of an aqueous solution of 50 mg/L of dioctyl sodium sulfosuccinate was poured onto the culture plate on which the spores were formed, and the spores were gently scrapped off using a disposable loop and dispersed into the aqueous solution. The aqueous solution into which the spores were dispersed was collected using a pipette, and after removing the fungal filaments through filtering through an eight-ply sterile gauze, the filtrate was centrifuged for 10 minutes at 1400 g, and the supernatant was removed. 10 mL of sterile distilled water was added to the precipitated spores, and, after rinsing, centrifugation was performed again under the same conditions. After repeating this three times, the spores were suspended in 5 mL of sterile distilled water, to produce a spore fluid.

Measuring the Fluorescence Intensity Using a Fluorescent Microscope under Dry Conditions

A drop of the polystyrene particle suspension or microorganism suspension was placed onto a slide glass and dried in a dark location and then examined under a fluorescent microscope (Olympus Corp.: Model BX51). For excitation by light in the vicinity of the 340 nm wavelength, the U-MWU2 mirror unit was used, and for excitation by light in the vicinity of the 405 nm wavelength, the U-MNV2 mirror unit was used. The polystyrene particles or microorganisms were observed using an UMPlanFL×100 objective lens, without covering the slide glass with a cover glass. The stray light from the darkfield optical path was cut using the DIC slider. A fluorescent image of the polystyrene particles or microorganisms, and a brightfield image of the same field of view were captured using a DP-70 CCD camera (Olympus Corp.) connected to the microscope.

The fluorescent image that was taken was converted into an eight-bit grayscale image using Image-Pro +6.3 J (Media Cybernetics, Inc.) image analyzing software to detect the polystyrene particles or microorganisms in the fluorescent image. The per-polystyrene-particle fluorescence intensity was calculated by summing the grayscale values of the pixels in a range identified as a particle by the image analyzing software. At this time, the average grayscale value of pixels in an arbitrary range containing no particles within the image was calculated and defined as the background value, where this background value was subtracted from the grayscale values of the respective pixels within the range identified as a particle to correct the per-polystyrene-particle fluorescence intensity. If an aggregation of a plurality of polystyrene particles was identified as a single particle, then, based on the brightfield image, the number of particles therein was evaluated, and the fluorescence intensity of the aggregation of particles was divided by the number of particles to calculate the average per-polystyrene-particle fluorescence intensity. The per-microorganism fluorescence intensity was also calculated using the same technique.

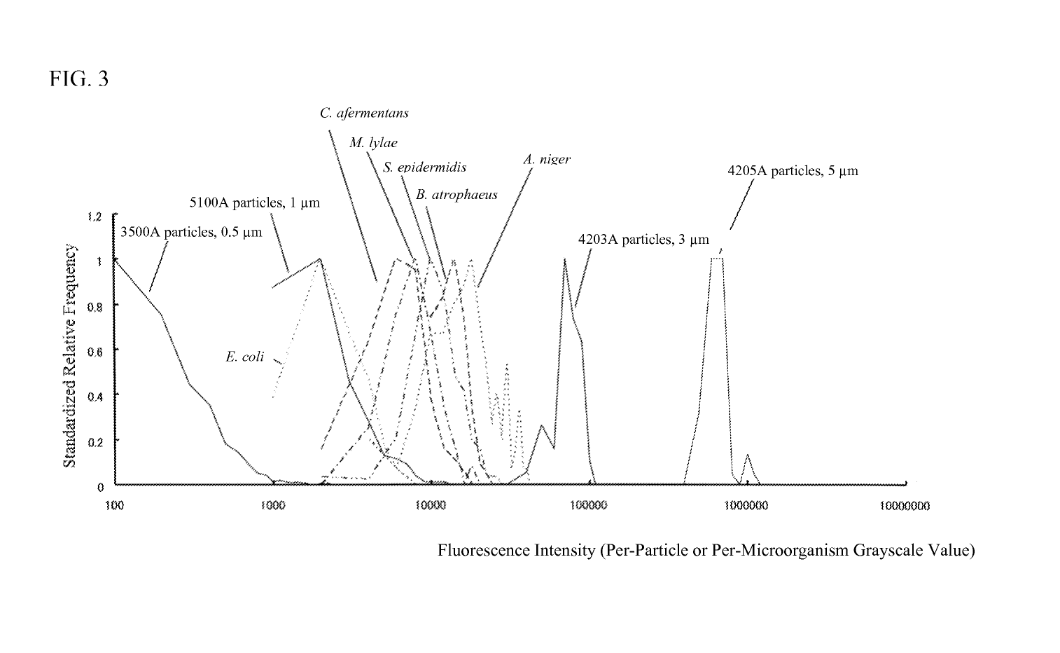

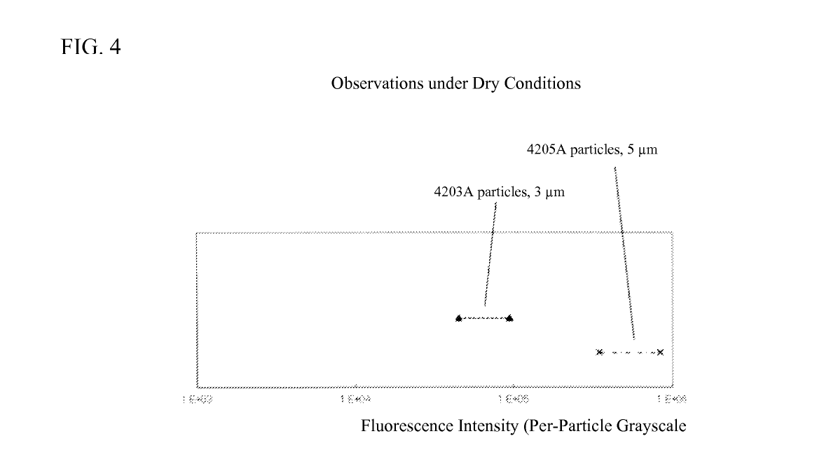

In the case of using excitation light in the vicinity of a 405 nm wavelength, the distribution of fluorescence intensities of the polystyrene particles and of the microorganisms were as shown in FIG. 3. FIG. 4 is a graph showing the 95% confidence intervals calculated for fluorescence intensities for polystyrene particles of product no. 4203A and product no. 4205A. As shown in FIG. 3, the product no. 5100A particles and the product no. 4203A particles produced fluorescence with intensities similar to those of the microorganisms. The intensity of the fluorescence produced by the product no. 5100A particles was particularly close to the intensity of the fluorescence produced by the C. afermentans, the M. lylae, and the E. coli. The intensity of the fluorescence produced by the product no. 4203A particles was particularly close to the intensity of the fluorescence produced by the B. atrophaeus and the A. niger.

The intensity of the fluorescence produced by the product no. 3500A particles was weaker than the intensity of the fluorescence produced by the microorganisms. The intensity of the fluorescence produced by the product no. 4205A particles was stronger than the intensity of the fluorescence produced by the microorganisms.

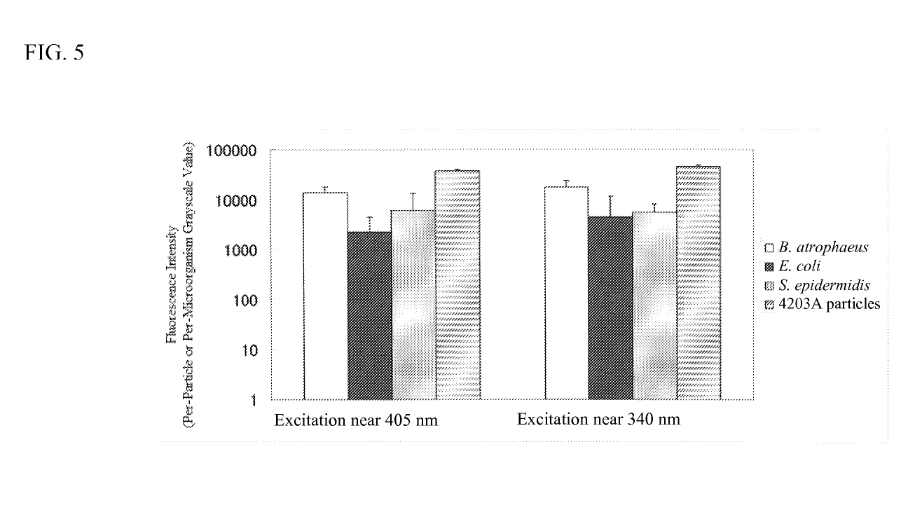

Moreover, when an excitation light in the neighborhood of a 405 nm wavelength and an excitation light in the neighborhood of a 340 nm wavelength were each used, the distributions of the fluorescence intensities of the polystyrene particles and the microorganisms were as shown in FIG. 5. As shown in FIG. 5, there were no remarkable changes in the intensities of fluorescence produced by the respective polystyrene particles or microorganisms even when the wavelength of the excitation light was changed.

### Relationship Between the Weight-Average Molecular Weight of the Polystyrene Particle Material and the Strength of Fluorescence

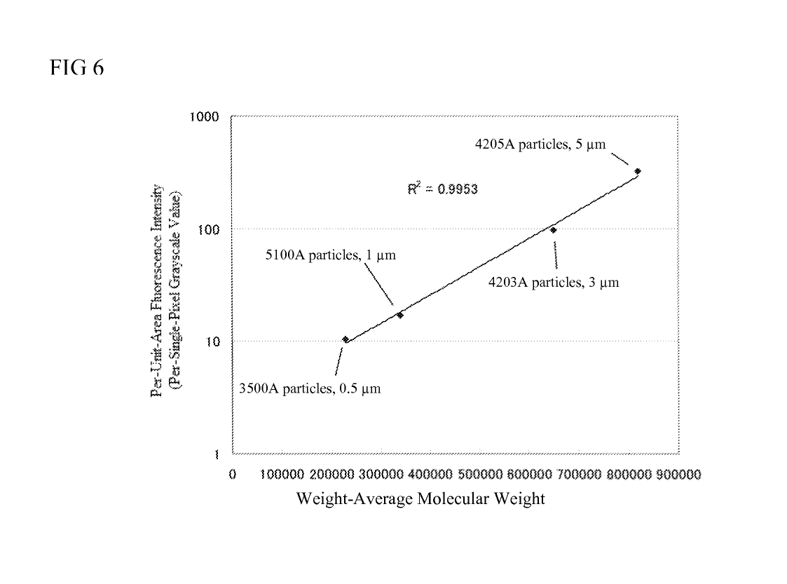

As illustrated in FIG. 6, when per-pixel strength of the fluorescent light produced by the polystyrene particles is plotted against the weight-average molecular weight of the material of the polystyrene particles, the greater the weight-average molecular weight of the material of the polystyrene particles, the stronger the fluorescent light that is produced by the polystyrene particles. Note that, in FIG. 6, the effect of the particle size on the strength of the fluorescent light is eliminated through plotting the per-pixel fluorescent light strength, rather than plotting the per-polystyrene-particle fluorescent light strength.

### Measuring the Fluorescence Intensity Using a Fluorescent Microscope Under In-Suspension Conditions

A drop of the suspension of polystyrene particles (product no. 4203A, or product no. 4205A) was placed onto a glass slide and covered with a cover glass, and then examined under a fluorescent microscope (Olympus Corp.: Model BX51) without being allowed to dry. The U-MNV2 mirror unit was used for excitation by light in the vicinity of the 405 nm wavelength. The polystyrene particles were observed using an UMPlanFL×100 objective lens, with the cover glass in place. The stray light from the darkfield optical path was cut using the DIC slider. A fluorescent image of the polystyrene particles and a brightfield image of the same field of view were captured using a DP-70 CCD camera (Olympus Corp.) connected to the microscope.

The fluorescent image that was taken was converted into an eight-bit grayscale image using Image-Pro +6.3 J (Media Cybernetics, Inc.) image analyzing software to detect the polystyrene particles in the fluorescent image. The per-polystyrene-particle fluorescence intensity was calculated by summing the grayscale values of the pixels in a range identified as a particle by the image analyzing software. At this time, the average grayscale value of pixels in an arbitrary range containing no particles within the image was calculated and defined as the background value, where this background value was subtracted from the grayscale values of the respective pixels within the range identified as a particle to correct the per-polystyrene-particle fluorescence intensity. If an aggregation of a plurality of polystyrene particles was identified as a single particle, then, based on the brightfield image, the number of particles therein was evaluated, and the fluorescence intensity of the aggregation of particles was divided by the number of particles to calculate the average per-polystyrene-particle fluorescence intensity.

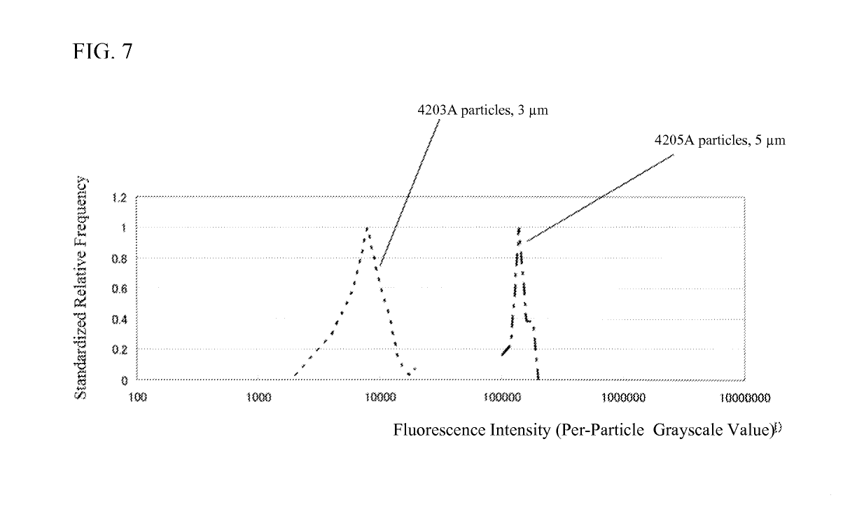

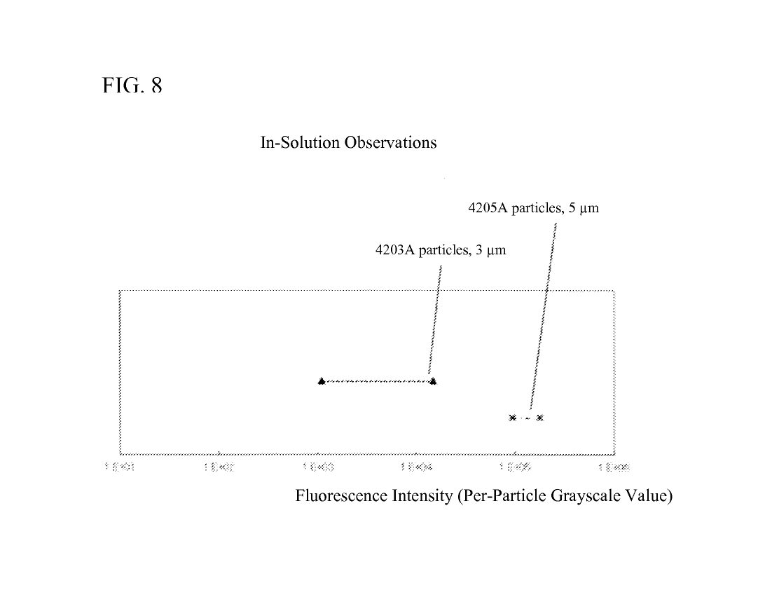

In the case of using excitation light in the vicinity of a 405 nm wavelength, the distribution of fluorescence intensities of the polystyrene particles was as shown in FIG. 7. FIG. 8 is a graph of the 95% confidence intervals calculated for the distributions of the fluorescent intensities. When observed in-fluid, the intensities of the fluorescence produced by the polystyrene particles, as a whole, lower when compared to those under dry conditions. However, the magnitude relationships of the fluorescence intensities as a function of the type of particle are substantially the same whether under dry conditions or under in-fluid conditions. For example, as shown in FIG. 4, under dry conditions there is a tendency for there to be increasing fluorescent intensity in the following sequence: product no. 4203A and product no. 4205A. In this regard, as shown in FIG. 8, in-fluid as well, there is a tendency for there to be increasing fluorescent intensity in the following sequence: product no. 4203A and product no. 4205A. When observed in-fluid, the intensities of the fluorescence produced by the microorganisms particles, as a whole, are also lower when compared to those under dry conditions. Consequently, the fluorescence intensities of the polystyrene particles are near to the fluorescence intensities of the microorganisms, even in the suspension.

### Measuring the Fluorescence Intensity Using the Microorganism Detecting Apparatus

The measurement of the fluorescence intensity by the microorganism detecting apparatus was according to the Journal of Aerosol Science, Vol. 42, 397-407, 2011. That is, the air within a chamber was cleaned through operating a HEPA filter unit in a closed chamber with a volume of 3 m³ provided with a HEPA filter unit. Thereafter, a suspension of either polystyrene particles or microorganisms was sprayed for 20 seconds with a flow rate of 5 L/minute using a nebulizer (Salter Labs, Inc.: REF8900) to produce a suspension within the air in the chamber. Thereafter, the air within the chamber was agitated for 30 seconds, both to dry any water droplets and to uniformly disperse the polystyrene particles or microorganisms. Thereafter, the air within the chamber was measured, using an airborne microbe detector (Azbil BioVigilant Inc.: IMD-A300) as the microorganism detecting apparatus, for 60 seconds, to detect the polystyrene particles or microorganisms in the air. The fluorescence intensities detected for the polystyrene particles or microorganisms were obtained as detection voltage values for the fluorescence detector of the airborne microbe detector.

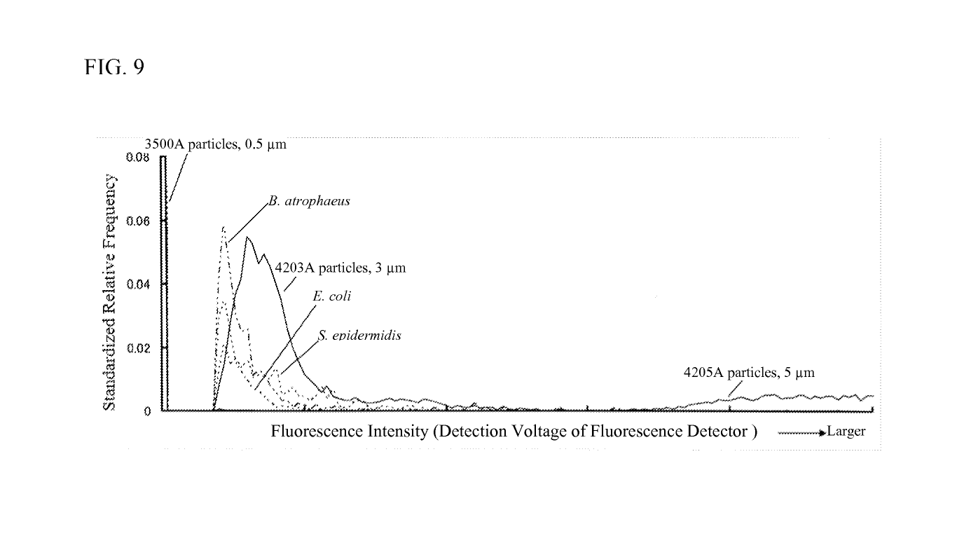

The distributions of the fluorescence intensities for the polystyrene particles and the microorganisms, measured by the airborne microbe detector, were as shown in FIG. 9. Even when measured by the airborne microbe detector, the fluorescence intensities of the polystyrene particles were found to be near to the fluorescence intensities of the microorganisms.

1. A method for calibrating a microorganism detecting apparatus comprising:
drawing into the microorganism detecting apparatus polystyrene particles with a weight-average molecular weight of no less than 250,000 and no more than 850,000 that, when exposed to light, produce a fluorescence of an intensity that is substantially identical to an intensity of fluorescence produced by a microorganism;
exposing the polystyrene particles to light from a light source of the microorganism detecting apparatus and detecting, with a fluorescence detector of the microorganism detecting apparatus, the fluorescence produced by a polystyrene particle; and
calibrating the microorganism detecting apparatus based on a detected intensity of the fluorescence.

2. The method for calibrating a microorganism detecting apparatus as set forth in claim 1, wherein
the diameter of the polystyrene particle is no less than 0.75 μm and less than 10 μm.

3. The method for calibrating a microorganism detecting apparatus as set forth in claim 1, wherein
the polystyrene particle essentially is made from polystyrene.

4. The method for calibrating a microorganism detecting apparatus as set forth in claim 1, wherein
wherein the microorganism includes a bacterium.

5. The method for calibrating a microorganism detecting apparatus as set forth in claim 4, wherein
the bacterium includes one or more selections from a Gram-negative bacterium such as Escherichia coli, a Gram-positive bacteria such as Staphylococcus epidermidis, Bacillus atrophaeus, Micrococcus lylae, and Corynebacterium afermentans, and a fungus such as a mold spore.

6. The method for calibrating a microorganism detecting apparatus as set forth in claim 1, wherein
the light is visible light.

7. The method for calibrating a microorganism detecting apparatus as set forth in claim 1, wherein
the light has a wavelength between 400 and 410 nm.

8. The method for calibrating a microorganism detecting apparatus as set forth in claim 1, wherein
the light is ultraviolet radiation.

9. The method for calibrating a microorganism detecting apparatus as set forth in claim 1, wherein
the light has a wavelength between 310 and 380 nm.

10. The method for calibrating a microorganism detecting apparatus as set forth in claim 1, wherein
in the exposure of the polystyrene particle to light from a light source of the microorganism detecting apparatus, the polystyrene particle is dry.

11. The method for calibrating a microorganism detecting apparatus as set forth in claim 1, wherein
in the exposure of the polystyrene particle to light from a light source of the microorganism detecting apparatus, the polystyrene particle is in a fluid.

12. A kit for calibrating a microorganism detecting apparatus, comprising:
a polystyrene particle with a weight-average molecular weight of no less than 250,000 and no more than 850,000 that, when exposed to light, produces a fluorescence of an intensity that is substantially identical to an intensity of fluorescence produced by a microorganism.

13. The kit for calibrating a microorganism detecting apparatus as set forth in claim 12, wherein
the diameter of the polystyrene particle is no less than 0.75 μm and less than 10 μm.

14. The kit for calibrating a microorganism detecting apparatus as set forth in claim 12, wherein
the polystyrene particle essentially is made from polystyrene.

15. The kit for calibrating a microorganism detecting apparatus as set forth in claim 12, wherein
the microorganism includes a bacterium.

16. The kit for calibrating a microorganism detecting apparatus as set forth in claim 15, wherein
the bacterium includes one or more selections from a Gram-negative bacterium such as Escherichia coli, a Gram-positive bacteria such as Staphylococcus epidermidis, Bacillus atrophaeus, Micrococcus lylae, and Corynebacterium afermentans, and a fungus such as a mold spore.

17. The kit for calibrating a microorganism detecting apparatus as set forth in claim 12, wherein
the light is visible light.

18. The kit for calibrating a microorganism detecting apparatus as set forth in claim 12, wherein
the light has a wavelength between 400 and 410 nm.

19. The kit for calibrating a microorganism detecting apparatus as set forth in claim 12, wherein
the light is ultraviolet radiation.

20. The kit for calibrating a microorganism detecting apparatus as set forth in claim 12, wherein
the light has a wavelength between 310 and 380 nm.

21. The kit for calibrating a microorganism detecting apparatus as set forth in claim 12, wherein
the polystyrene particle, when exposed to light in a state wherein it is dry, produces fluorescence of an intensity substantially equal to the intensity of fluorescence produced by a microorganism when in a state wherein it is dry.

22. The kit for calibrating a microorganism detecting apparatus as set forth in claim 12, wherein
the polystyrene particle, when exposed to light when in a fluid, produces fluorescence of an intensity substantially equal to the intensity of fluorescence produced by a microorganism when in a state when in a fluid.
